(19) United States
(12) Patent Application Publication
(10) Pub. No.: US 2009/0233069 A1
(43) Pub. Date: Sep. 17, 2009

(54) REDUCTION OF TRANSFER OF VIBRATIONS

(75) Inventors: Nicolas Merlette, Suilly la Tour (FR); Philippe Belle, Bannay (FR)

Correspondence Address: HENKEL CORPORATION, 1001 TROUT BROOK CROSSING, ROCKY HILL, CT, 06067, US

(73) Assignee: Henkel AG & Co. KGaA, Duesseldorf (DE)

(21) Appl. No.: 12/364,572

(22) Filed: Feb. 3, 2009

Related U.S. Application Data
(63) Continuation of application No. PCT/EP2006/007706, filed on Aug. 3, 2006.

(30) Foreign Application Priority Data
Aug. 3, 2006 (EP) EP2006/007706

(51) Int. Cl. B60R 13/08; B32B 7/02; G10K 11/16; F16F 15/00

(52) U.S. Cl. 428/212; 156/60; 156/83; 181/207

(57) ABSTRACT

The invention discloses a dissipative vibration damping device (1), comprising a carrier (2) having an inner surface and an outer surface, the carrier being comprising on at least one surface thereof a bonding layer (3), wherein the carrier (2) is dissipative and has a damping loss factor of at least 0.2 and wherein the bonding layer (3) is made of a rigid material with higher stiffness than the carrier (2). Also disclosed is a system and a method using such dissipative damping device.

### CROSS-REFERENCE TO RELATED APPLICATIONS

This application is a continuation under 35 U.S.C. Sections 365(c) and 120 of International Application No. PCT/EP2006/007706, Aug. 3, 2006, which is incorporated herein by reference in its entirety.

### FIELD OF INVENTION

The present invention relates to the reduction of the transfer of vibrations generated by a vibration generator.

### BACKGROUND OF INVENTION

In a vehicle, the transfer of vibrations generated by a dynamic force generator, such as an engine, a motor, a pump or a gear box, via structural elements to an emitting surface such as a panel, leads to the emission of structure-borne noise.

Different solutions have been suggested in order to at least reduce such structure-borne noise. In vehicle construction, passive measures such as the recourse to vibration dampers or dampening mats have been proposed. Such dampening mats are often applied on vibrating panels, e.g. in the doors or on the floor of a vehicle. The extent of noise reduction of these methods is satisfactory, but their drawbacks are numerous.

In the conventional process, mixtures of bitumen or asphalt and fillers with a high specific weight are extruded into sheets, from which the appropriate shapes are punched or cut. These sheets are then bonded to the appropriate metal sheet parts and must sometimes also be adapted to the shape of the sheet by heating. Although these bitumen sheets are still frequently used because of their low material cost, they are very brittle and tend to peel off from the metal sheet particularly at low temperatures. Also incorporation of additives which has often been proposed only results in a slight improvement which is not sufficient for many applications. Moreover, it is completely impossible to apply the pre-formed bitumen parts to the complex-shaped or almost inaccessible metal sheet parts of machines or vehicles, e.g. the inner surfaces of the cavities of motor vehicle doors. In addition there is the further disadvantage that in many cases several punched parts are required for only one vehicle or appliance and therefore costly storage is required.

There has consequently been no lack of attempts to eliminate the disadvantages of bitumen sheets using other polymer systems. For example, aqueous polymer dispersions of polyvinylacetate or ethylene-vinylacetate copolymers containing fillers were developed which can be sprayed on to the metal sheet parts with the necessary coating thickness. These systems are, however, disadvantageous for industrial use when there are high rates of production because the water cannot be removed rapidly enough from the coating that is sprayed on, particularly when this coating is fairly thick.

The sound damping properties of polymer coatings are best in the range of the glass transition temperature of the polymer system, because due to the viscoelasticity of the polymer in this temperature range the mechanical energy of the vibration process is converted into heat by molecular flow phenomena. Conventional sprayable coating materials based on polyvinyl chloride (hereinafter PVC) plastisols, which e.g. are widely used as an underbody coating in motor vehicle construction, have no notable sound damping effect in the application temperature range of −20 to +60° C. because the maximum value of the glass transition is about −20° C. to −50° C. depending on the proportion of plasticizer.

Attempts were therefore made to modify these conventional PVC plastisols so that they would have better sound damping properties in the application temperature range of −20° C. to +60° C. Coatings are known from German published patent application 35 14 753 which contain multiple-unsaturated compounds, e.g. di- or triacrylate, peroxide cross-linking agents and inorganic fillers, in conventional PVC plastisols. In the hardened state these plastisols are, however, glass-hard and brittle, and are therefore not really suitable for use in automobile construction because they do not have sufficient flexibility particularly at low temperatures. Apart from this these formulations have a very low loss factor tan δ and thus the sound damping effect is not very marked.

Compositions are described in German published patent application 34 44 863 which contain PVC or vinylchloridelvinylacetate copolymers, optionally methylmethacrylate homopolymers or copolymers, a plasticizer mixture and inert fillers. The plasticizer mixture comprises plasticizers which are compatible with the methylmethacrylate polymers and plasticizers for the vinylchloride polymers which are incompatible with the methacrylate polymers which may be present. The plastisols thus obtained have improved sound damping properties compared with conventional PVC plastisols. However, particularly at temperatures above about 30° C. the sound damping effect drops again. If an attempt is made to shift the range of the maximum loss factor tan δ to higher temperatures by varying the relative quantities of the individual components, the cold flexibility of the coating drops very severely. A reduced cold flexibility is, however, precisely what is disadvantageous in vehicle construction. In addition the loss factor decreases very severely at lower temperatures with these formulations. These plastisol compositions therefore have a sufficiently high loss factor only in a very narrow temperature range.

Furthermore, active control methods for reducing structure-borne noise have been developed. These methods usually employ sensors, signal processing, actuators, and power sources to counteract or effectively increase the dissipation of the vibration by producing corresponding forces or strains.

Although active control methods have been shown to effectively reduce structure-borne noise, they require sophisticated technical equipment, especially with respect to signal processing and sensors. This does not only increase the costs, but also leads to an increased risk of breakdown.

Therefore, there is a need for economic means for effectively reducing structure-borne noise in a system, especially in a vehicle.

In the unpublished European Patent Application No. 05292082.4 there is disclosed a dissipative vibratory wave barrier comprising a carrier having an inner surface and an outer surface, the carrier having a polygonal section, especially rectangular, optionally U-shaped and comprising on its outer surface a coating comprising a thermo-expandable material selected among those which, after expansion and at a temperature between −10 and +40° C., have a Young modulus E between 0.1 MPa and 1000 MPa, a loss modulus E″ between 0.5 and 1 and a Shear modulus G between 0.1 MPa and 500 MPa. The moduli, especially the loss modulus, are usually determined by dynamic mechanical analysis (DMA).

Although the known dissipative vibratory wave barrier shows excellent vibration damping efficiency in some applications a problem exists in cases where the structure to be damped is very stiff. Because of the need of a very stiff carrier in the known dissipative vibratory wave barrier which should have at least similar stiffness to the structure to be damped this results in very massive carriers, which is often not acceptable for cost and lightweight reasons, especially in automotive applications.

It is therefore an object of the present invention to overcome the drawbacks of the prior art.

### SUMMARY OF THE INVENTION

According to the invention there is proposed a dissipative vibration damping device, comprising a carrier having an inner surface and an outer surface, the carrier comprising on at least one surface thereof a bonding layer, wherein the carrier is dissipative and has a damping loss factor of at least 0.2 and wherein the bonding layer is made of a rigid material with higher stiffness than the carrier.

Since the carrier of the dissipative vibration damping device according to the invention is the dissipative element, the carrier is deformed by the vibrations of the treated structure and absorbs and dissipates the vibrations generating mostly heat. According to this there is no need to provide a carrier with high stiffness even in cases where the treated structure exhibits such high stiffness, thus leading to very lightweight and economical interesting dissipative vibration damping devices.

The bonding material of the dissipative vibration damping device according to the invention is made of a rigid material and serves to securely connect the dissipative vibration damping device to the treated structure and to transfer the vibrations from the treated structure to the dissipative carrier.

The carrier of the dissipative vibration damping device according to the invention can be made of any suitable material showing the requested dissipative characteristics.

According to a first preferred embodiment of the invention the carrier is made of a synthetic material, optionally fiber re-enforced, and especially of a thermoplastic synthetic material, selected within the group consisting of polyamides (PA), polyphenylene sulphide (PPS), polyphenylene ether (PPE), polyphenylene sulfone (PPSU) and polyphenylene-imide (PPI), the thermoplastic synthetic material being optionally fiber re-enforced, having a low water absorption and a stability of dimension up to 180° C.

As a second preferred embodiment of the invention the carrier is made of a viscoelastic sandwich material of at least two layers.

Examples of the viscoelastic sandwich material comprise at least one layer made of metal, and especially of steel or of aluminum and at least one layer based on a viscoelastic rubber material.

The viscoelastic rubber material preferably has a thickness of 1.4 to 1.8 mm and/or a loss factor according to DIN 53440 of at least 0.10 in a temperature range of −15° C. to +65° C. and/or an area weight of 1.0 to 2.0 kg/m², preferably 1.2 kg m².

For excellent vibration damping efficiency the carrier of the dissipative vibration damping device according to the invention has a damping loss factor of at least 0.5.

Generally, the loss factors of a system can be defined as

$$η ( ω ) = \frac{Δ E}{{E}_{SE}} ,$$

where E_{SE} is the strain energy, ΔE is the energy dissipated from damping and η is the damping loss factor in the frequency band ω considered. Therefore, η is equal to the rate of the strain energy dissipated per cycle.

When the damping loss factor η is for example equal to 0.2, it means that 20% of the initial energy used to excite the material is dissipated during the first cycle. A damping loss factor higher than 1 will mean that the material dissipates all the energy in less than 1 cycle.

One way of measurement can be the use of a DMA (Dynamic Mechanical Analyzer) where a sample is excited on one edge and the response is measured on the other. In that case the damping loss factor η is

η32 tan(δ)

where δ is the phase difference between the excitation and the response.

Any suitable material providing rigid characteristics with good adherence both to the carrier and the structure to be treated and good transfer of the vibrations to the dissipative carrier can be used as the bonding layer according to the invention.

A preferred embodiment of the bonding layer according to the invention comprises a two-component epoxy resin foam having a density in uncured state of 0.75 to 0.95 kg/m³ and a water absorption of less than 5%.

For sufficient rigidity the bonding layer preferably has a compression strength of at least 10.5 MPa.

Further, the bonding layer can be made of a material which is expandable upon heating with an expansion ratio of 55 to 65%. Such expandable bonding layer allows the introduction of the dissipative damping device according to the invention into a structure or fixation onto a structure with a clearance there between which will be closed upon heating of the equipped structure due to the expansion of the bonding layer.

The bonding layer may have a Young's modulus of 1 to 10,000 MPa, preferably 500 to 2,000 MPa.

The present invention also relates to a system comprising a structural element, e.g. an automotive part, and a dissipative vibration damping device as described above, wherein the dissipative vibration damping device is connected to the structural element by the bonding layer of the dissipative vibration damping element and the carrier thereof having a stiffness lower than the stiffness of the structural element for effective dissipative operation.

The present invention also relates to a method for reducing the transfer of vibrations from a vibration generator to a location to which the vibration generator is connected via a structural element, comprising equipping said structural element with means for dissipating vibrational energy generated by the vibration generator, characterized in that the means for dissipating vibrational energy comprise a dissipative vibration damping device according to the present invention as described herein.

Examples of vibration generators include motors, engines, pumps, gear boxes, suspension dampers and springs.

The method according to the present invention is particularly adapted for reducing structure-borne noise in an automobile vehicle. In this case the vibration generator is connected to at least one of the constitutive parts of the passenger compartment of said vehicle via a structural element. The shape of the structural element is that of a tubular rail with a polygonal, preferably rectangular cross-section.

The method according to the present invention comprises successively,
selecting a dissipative vibration damping device according to the present invention having dimensions such that it can be inserted into or fixed onto the structural element, with the stiffness of the carrier being lower than the stiffness of the structural element,
inserting the dissipative vibration damping device into or fixing the dissipative vibration damping device onto the structural element in a location close to the vibration generator and connecting the dissipative vibration damping device with the structural element by the bonding layer.

Advantageously, the bonding layer is expanded upon heating in a successive heating step.

Advantageously, the dissipative vibration damping device is selected such that a clearance of about 1 to 20 mm between the surface of the dissipative vibration damping device facing the surface of the structural element is obtained and the clearance is closed upon heating.

The dissipative vibration damping device is preferably inserted into the structural element as close as possible to the vibration generator and before the receiving vibrating structure from which the sound is generated.

Expansion of the expandable material is obtained by a heating step.

Depending on the nature of the bonding material and the line conditions at the assembly line, the heating step is carried out at a temperature from 130° C. to 240° C., preferably from 150° C. to 200° C. with a residence time in the oven from residence about 10 min. to about 30 min.

It is desirable to take advantage of the heating step that follows the passage of the vehicle parts in the generally used electro coating bath (E-coat bath) to cause expansion of the bonding layer as the temperature during this heating step is generally sufficient to cause the expected expansion.

The thickness of the bonding layer that is applied to the carrier is selected such that, after expansion, its volume occupies the clearance between the carrier and the respective surface of the structural element thus ensuring a secure connection and good vibration transfer to the dissipative carrier.

### BRIEF DESCRIPTION OF THE DRAWINGS

The above and other objects, features and advantages of the present invention will become more apparent from the following description of preferred embodiments, reference being made to the accompanying figures, in which:

FIG. 1 is a schematic side view of a dissipative vibration damping device according to the present invention connected to a structural member of an automobile;

FIG. 2 is a schematic perspective view of a carrier used in a dissipative vibration damping device according to the present invention,

FIG. 3 is a graph showing three curves representing the variation of the structure-borne noise in a car body as a function of frequency.

### DETAILED DESCRIPTION OF PREFERRED EMBODIMENTS

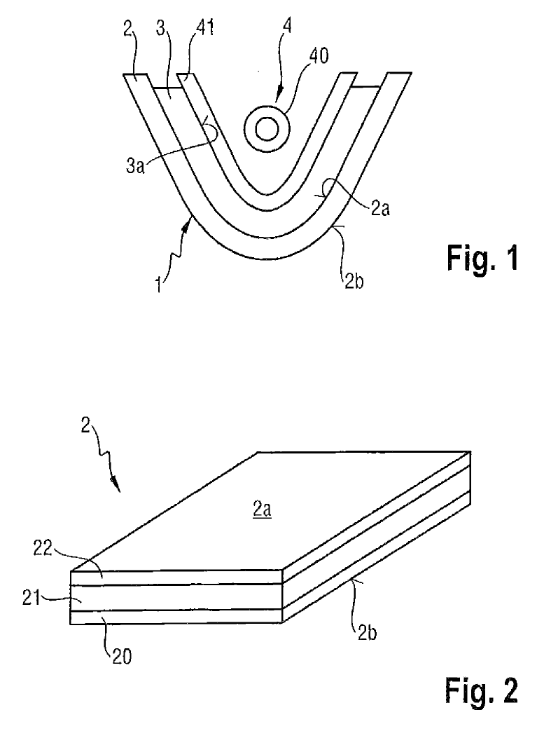

The dissipative vibration damping device 1 shown in FIG. 1 comprises a U-shaped carrier 2 having an inner surface 2a and an outer surface 2b. A bonding layer 3 comprising a two-component epoxy resin foam is applied to the inner surface 2a. The initial thickness of the bonding layer 3 is selected such that there remains a clearance of about 2 mm between the inner surface 3a of the bonding layer 3 and a structure 4 to be treated, for example.

The U-shaped carrier 2, which can be seen in more detail in FIG. 2 is made of a viscoelastic sandwich material comprising three layers 20, 21, 22 in stacked arrangement.

The outer layers 20, 22 of the carrier 2 are made of metal sheets having a thickness of 0.5 mm each. Preferred metals are galvanized steel and aluminum.

The intermediate layer 21 of the carrier consists of a viscoelastic rubber material having a thickness of 1.5 mm and an area weight of about 1.2 kg/m² and is securely bonded to the outer layers 20, 22 thus constituting a three layer structure.

As an alternative, the carrier 2 can be made of a single layer using a suitable synthetic material showing dissipative properties. When using a synthetic material, this may optionally be fiber re-enforced. The synthetic materials are selected from those hereabove recited. The thickness of the carrier 2 is approximately 2.5 mm.

The following non-limiting example illustrates the invention and the manner of practicing the same.

As shown in FIG. 1, the dissipative vibration damping device 1 is fixed onto a structural element 4 of a car body, for example onto a rear suspension system having a suspension rail 41 and an anti-banking beam 40 with the bonding layer 3 facing the structural element 4. The dissipative vibration damping device has a carrier (2) approximately U-shaped having dimensions as to partly surround the structural element 4 while maintaining the clearance between the applied bonding layer 3 and the structural element 4 as referred above (in this case about 2 mm between the bonding layer 3 and the structural element 4).

After the fixation of the dissipative vibration damping device 1, the structural element 4 is heated to a temperature of 180° C. for 20 min in order to cause expansion of the bonding layer 3 in the space between the inner surface 2a of the carrier 2 and the outer surface of the structural element 4. After the heating, the bonding layer 3 has an enlarged thickness so that it is in connecting contact with the structural element 4. The expansion can be realizing during the passage of the vehicle parts in the electro coating bath.

In other examples, the dissipative vibration damping device 1 can be selected such that the clearance between the outer surfaces of the dissipative vibration damping device 1 and the surfaces of the structural element 4 is about 1 to 20 mm. In all these cases, after the heating, the bonding layer 3 occupies all the clearance.

As an alternative, a bonding layer 3 can be used which allows expansion without a heating process, for example due to chemical reaction of its components. The bonding layer 3 should have a Young's modulus of 1 to 10,000 MPa, preferably 500 to 2,000 MPa.

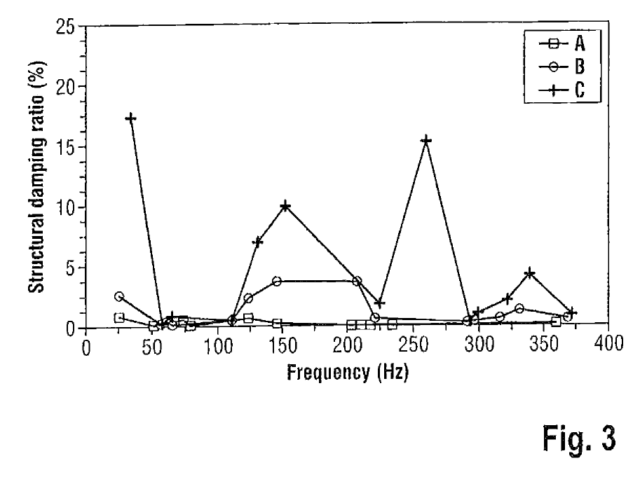

FIG. 3 shows the results of an experiment carried out using a real structural element of a car. In this experiment, the dissipative vibration damping device was located on the rear suspension system.

A dynamic shaker was used as vibration generator and was attached at a free end of the structural member and provided an excitation in the low frequency range from 20 Hz up to 380 Hz.

The injected vibration was measured by means of a force sensor located at the entry point.

The response was measured by means of accelerometers in form of the structural damping ratio.

Three experiments were conducted:
without any added damping material on the vibration transfer path (curve A on FIG. 3).
a dissipative vibratory wave barrier according to the unpublished European Patent Application EP 05292082.4 was used (curve B on FIG. 3).
the dissipative vibration damping device according to the invention as described below was used (curve C on FIG. 3).

The dissipative vibration damping device according to the invention had a carrier 2 consisting of two outer layers 20, 22 of steel, each 0.5 mm thick. Therebetween was located a layer 21 consisting of a viscoelastic rubber material in a thickness of 1.5 mm.

This dissipating carrier may contain a conventional sound damping material known in the art. Examples can be found in the “Terophon®” product range commercially available from Henkel AG & Co. KGaA. For example, a suitable sound damping material comprises, in % by weight:
8 to 15% of butyl rubber,
20 to 40% of polyolefins, preferably selected from polyisobutylene, polybutene, or mixtures thereof,
10 to 15% of aliphatic hydrocarbon resin,
2 to 10% of formaldehyde resin,
the remainder to 100% being fillers selected from, for example, barium sulphate, calcium oxide, calcium carbonate, muscovite, quartz, and carbon black

Alternatively, the sound damping material may comprise, in % by weight:
40 to 70% of polyolefins, preferably selected from polyisobutylene, polybutene, or mixtures thereof,
the remainder to 100% being fillers selected from, for example, barium sulphate, calcium oxide, calcium carbonate, muscovite, quartz, and carbon black

Furthermore, the sound damping materials described in the working examples of EP 697277 or EP 617098 may be used for the present invention.

Thus, a three layer viscoelastic sandwich material of the structure as shown in FIG. 2 was used as the carrier 2. The layer 21 had an area weight of 1.2 kg/m² and a loss factor according to DIN 53440 of at least 0.10 at −15° C. up to +65° C. The carrier 2 showed less stiffness than the structural element 4.

The material for the bonding layer 3 may be selected from conventional foamable reinforcing materials known in automotive manufacturing. For examples, such materials are commercially available from Henkel AG & Co. KgaA under the trade name of “Terocore®”. They usually are mixtures of epoxy resins, modifiers, curing agents, blowing agents, and light weight fillers. Examples of suitable materials can be found in the description and the working examples of WO03/054069, WO00/52086, and WO2004/065485.

In a particular embodiment, a material was employed which is commercially available under the brand name “Terocore®” in the product range of Henkel AG & Co. KgaA. This bonding layer 3 showed a density in uncured state of about 0.75 to 0.95 kg/m³ and about 0.55 to 0.65 kg/m³ in the cured state. Its water absorption was less than 5% and the compression strength was at least 10.5 MPa. During expansion it showed an expansion rate of about 55 to 65%.

From curves A, B and C, it appears that in the given frequency range the present invention yields to considerably improved vibration damping and significant noise reduction.

The principal advantages of the invention are as follows:
much less material is necessary to damp the vibration of the structure to be treated,
the use of the dissipative vibration damping device according to the invention is much cheaper in term of process costs for the car or machinery manufacturer compared to the application of damping material according to the prior art,
since the carrier is dissipative and therefore shows less stiffness than the structure to be treated, the dissipative vibration damping device according to the invention is very lightweight.

The use of the dissipative vibratory wave barrier according to the invention may also contribute to the rigidity of the treated structure thus improving the safety and comfort of the vehicle.

What is claimed is:

1. A dissipative vibration damping device, comprising a carrier having an inner surface and an outer surface, the carrier comprising a bonding layer on at least one of said inner surface and said outer surface, wherein the carrier is dissipative and has a damping loss factor of at least 0.2; and the bonding layer is made of a rigid material with a stiffness greater than the carrier.

2. The dissipative vibration damping device according to claim 1, wherein the carrier comprises a thermoplastic synthetic material, optionally fiber re-enforced.

3. The dissipative vibration damping device according to claim 2, wherein the thermoplastic synthetic material, optionally fiber re-enforced, is selected from the group consisting of polyamides (PA), polyphenylene sulphide (PPS), polyphenylene ether (PPE), polyphenylene sulfone (PPSU) and polyphenylene-imide (PPI), having a low water absorption and a stability of dimension up to 180° C.

4. The dissipative vibration damping device according to claim 1, wherein the carrier is made of a viscoelastic sandwich material of at least two layers.

5. The dissipative vibration damping device according to claim 4, wherein the sandwich material comprises at feast one layer of metal and at least one layer based on a viscoelastic rubber material.

6. The dissipative vibration damping device according to claim 5, wherein the viscoelastic rubber material has a loss factor according to DIN 53440 of at least 0.10, in a temperature range of −15° C. to +65° C.

7. The dissipative vibration damping device according to claim 5, wherein the viscoelastic rubber material has an area weight of 1.0 to 2.0 kg/m².

8. The dissipative vibration damping device according to claim 4, wherein the carrier has a damping loss factor of at least 0.5.

9. The dissipative vibration damping device according to claim 1, wherein the bonding layer comprises a two-component epoxy resin foam having a density in uncured state of 0.75 to 0.95 kg/m³ and a water absorption of less than 5 wt %.

10. The dissipative vibration damping device according to claim 1, wherein the bonding layer has a compression strength of at least 10.5 MPa.

11. The dissipative vibration damping device according to claim 1, wherein the bonding layer has a Young's modulus of 1 to 10,000 MPa.

12. A system comprising a structural element and a dissipative vibration damping device according to claim 1, wherein the dissipative vibration damping device is connected to the structural element by the bonding layer of the dissipative damping device and the carrier of the dissipative damping device has a lesser stiffness than the structural element.

13. A method for reducing transfer of vibrations from a vibration generator to a location to which said vibration generator is connected via a structural element, comprising equipping said structural element with means for dissipating vibrational energy generated by the vibration generator, said means comprising a dissipative vibration damping device according to claim 1.

14. A method according to claim 13 wherein the vibration generator is comprised within an automobile vehicle; the location to which the vibration generator is connected via the structural element comprises at least one constitutive part of a passenger compartment of said automobile vehicle, and said structural element is in a form of a tubular rail.

15. A method for reducing transfer of vibrations from a vibration generator comprised within a vehicle to at least one constitutive part of a passenger compartment of said vehicle, said vibration generator being connected to the at least one constitutive part via a structural element, said method comprising, successively:
selecting a dissipative vibration damping device according to claim 1, having dimensions such that said device can be inserted into or fixed onto the structural element, and selected such that stiffness of the carrier is less than stiffness of the structural element; and
inserting the dissipative vibration damping device into or fixing the dissipative vibration damping device onto the structural element in a location close to the vibration generator and
connecting the dissipative vibration damping device with the structural element by the bonding layer.

16. The method according to any of the claims 15, wherein the bonding layer is expanded upon heating.

17. The method according to claim 15, wherein the dimensions of the dissipative vibration damping device are selected such that a clearance of about 1 to 10 mm between surfaces of the dissipative vibration damping device facing surfaces of the structural element is obtained and the clearance is closed upon heating.

18. The method according to claim 15, wherein said structural element is in a form of a tubular rail.

19. The method according to claim 18, wherein the tubular rail has a polygonal cross-section.
